(19) United States
(12) Patent Application Publication
(10) Pub. No.: US 2016/0125781 A1
(43) Pub. Date: May 5, 2016

(54) DISPLAY DEVICE AND DRIVING METHOD THEREOF

(71) Applicant: Samsung Display Co., Ltd., Yongin-si (KR)

(72) Inventor: Ji-Yeon YANG, Yongin-si (KR)

(21) Appl. No.: 14/882,443

(22) Filed: Oct. 13, 2015

(30) Foreign Application Priority Data
Nov. 5, 2014 (KR) 10-2014-0153037

(51) Int. Cl. G09G 3/20

(52) U.S. Cl. CPC G09G 3/2003; G09G 3/2074; G09G 2310/08; G09G 2310/0278; G09G 2300/0426; G09G 2300/0452; G09G 2320/0233; G09G 2320/0673

(57) ABSTRACT

Disclosed is a display device, including: a pixel unit including a first pixel column, in which first color pixels and second color pixels are alternately arranged, a second pixel column, in which the first color pixels and the second color pixels are alternately arranged in a reverse order to that of the first pixel column, and a third pixel column, in which third color pixels are arranged, disposed between the first pixel column and the second pixel column; a data driver generating data signals, and supplying the generated data signals to the pixel unit; and a gamma adjustor detecting a specific pattern based on the input data, adjusting at least one of gamma values when the specific pattern is detected, and outputting the adjusted gamma value to the data driver.

### CROSS-REFERENCE TO RELATED APPLICATION

This application claims priority from and the benefit of Korean Patent Application No. 10-2014-0153037, filed on Nov. 5, 2014, which is hereby incorporated by reference for all purposes as if fully set forth herein.

### BACKGROUND

1. Field

Exemplary embodiments relate to a display device and a driving method thereof

2. Discussion of the Background

Recently, a pentile type display device, which is capable of expressing high resolution compared to the number of pixels by using a sub pixel rendering scheme and minimizing design costs, has been proposed.

However, since the pentile type display device includes the less number of pixels compared to desired resolution, it is difficult to display a specific pattern, such as a micro pattern, with high definition.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide a display device, which prevents color-coordinate distortions when displaying a specific pattern in a pentile type display device, and a driving method thereof

Additional aspects will be set forth in the detailed description which follows, and, in part, will be apparent from the disclosure, or may be learned by practice of the inventive concept.

According to exemplary embodiments, a display device includes: a pixel unit including a first pixel column, in which first color pixels and second color pixels are alternately arranged, a second pixel column, in which the first color pixels and the second color pixels are alternately arranged in a reverse order to that of the first pixel column, and a third pixel column, in which third color pixels are arranged, disposed between the first pixel column and the second pixel column; a data driver configured to generate a first color data signal, a second color data signal, and a third color data signal in response to input data, and supply the generated data signals to the pixel unit; and a gamma adjustor configured to detect a specific pattern based on the input data, adjust at least one of a first color gamma value and a second color gamma value when the specific pattern is detected, and output the adjusted gamma value to the data driver.

The gamma adjustor may adjust at least one of the first color gamma value and the second color gamma value so as to increase luminance when the specific pattern is detected.

The gamma adjustor may adjusts the first color gamma value and the second color gamma value in accordance with a reference gamma value and output the adjusted first color and second color gamma values when the specific pattern is not detected.

The gamma adjustor may include: a pattern comparison unit configured to compare the input data with a reference pattern value, and output a result of the comparison; and a gamma value setting unit configured to set the first color gamma value and the second color gamma value based on the result of the comparison, and supply the set first color gamma value and second color gamma value to the data driver.

The gamma adjustor may further output a predetermined third color gamma value to the data driver.

The data driver may include: an input gamma unit configured to gamma convert at least one of first color input data and second color input data among the input data by applying the first color gamma value and the second color gamma value from the gamma adjustor, and output the gamma converted first color input data and second color input data; a sub pixel rendering unit configured to render an output value of the input gamma unit in accordance with a pixel arrangement structure of the pixel unit and output the rendered output value; an output gamma unit configured to inversely gamma convert an output value of the sub pixel rendering unit and output the inversely gamma converted output value; and a dithering unit configured to dither an output value of the output gamma unit and output the dithered output value.

The data driver may at least dithers third color input data among the input data.

According to exemplary embodiments, a method of driving a display device includes a pixel unit including a first pixel column, in which first color pixels and second color pixels are alternately arranged, a second pixel column, in which the first color pixels and the second color pixels are alternately arranged in a reverse order to that of the first pixel column, and a third pixel column, in which third color pixels are arranged, disposed between the first pixel column and the second pixel column, including: comparing input data with a reference pattern value, and setting at least one of a first color gamma value and a second color gamma value in response to a result of the comparison; detecting a specific pattern according to the result of the comparison between the input data and the reference pattern value; adjusting at least one of the first color gamma value and the second color gamma value; generating a first color data signal and a second color data signal corresponding to the input data by applying the first color gamma value and the second color gamma value, and a third color data signal corresponding to the input data; and driving pixels at luminance corresponding to the first color data signal, the second color data signal and third color data signal.

When the specific pattern is detected, at least one gamma value between the first color gamma value and the second color gamma value may be adjusted so as to increase luminance.

When the specific pattern is not detected, the first color gamma value and the second color gamma value may be set in accordance with a reference gamma value.

The generating of the first color data signal, the second color data signal and the third color data signal may include sub pixel rendering of rendering the input data or gamma converted input data in accordance with a pixel arrangement structure of the display unit.

According to exemplary embodiments, a display device comprises, a pixel unit in which the number of each first color pixels and a second color pixels is set to be a half of the number of third color pixels; a gamma adjustor adjusting and outputting at least one of a first color gamma value and a second color gamma value when input data corresponding to a predetermined specific pattern is supplied; a data driver generating at least one of a first color data signal and a second color data signal by applying at least one of the adjusted gamma values supplied from the gamma adjustor.

The gamma adjustor may output the reference gamma value as a gamma value of the third color pixels regardless of the predetermined specific pattern.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIGS. 1A and 1B are diagrams illustrating pixel arrangement structures by a stripe scheme and a pentile scheme respectively.

FIG. 2 is a diagram illustrating an example of a micro pattern displayed in a pixel unit.

FIGS. 3A and 3B are diagrams illustrating methods of displaying a micro pattern illustrated in FIG. 2 by the stripe scheme and the pentile scheme respectively.

FIG. 4 is a graph illustrating generation of luminance degradation when a micro pattern is displayed.

FIG. 5 is a diagram illustrating a display device according to an exemplary embodiment of the present invention.

FIG. 6 is a diagram illustrating an exemplary embodiment of a gamma adjustor and a data driver illustrated in FIG. 5.

FIG. 7 is a graph illustrating compensation for luminance degradation when a micro pattern is displayed by adopting the exemplary embodiment of the present invention.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof

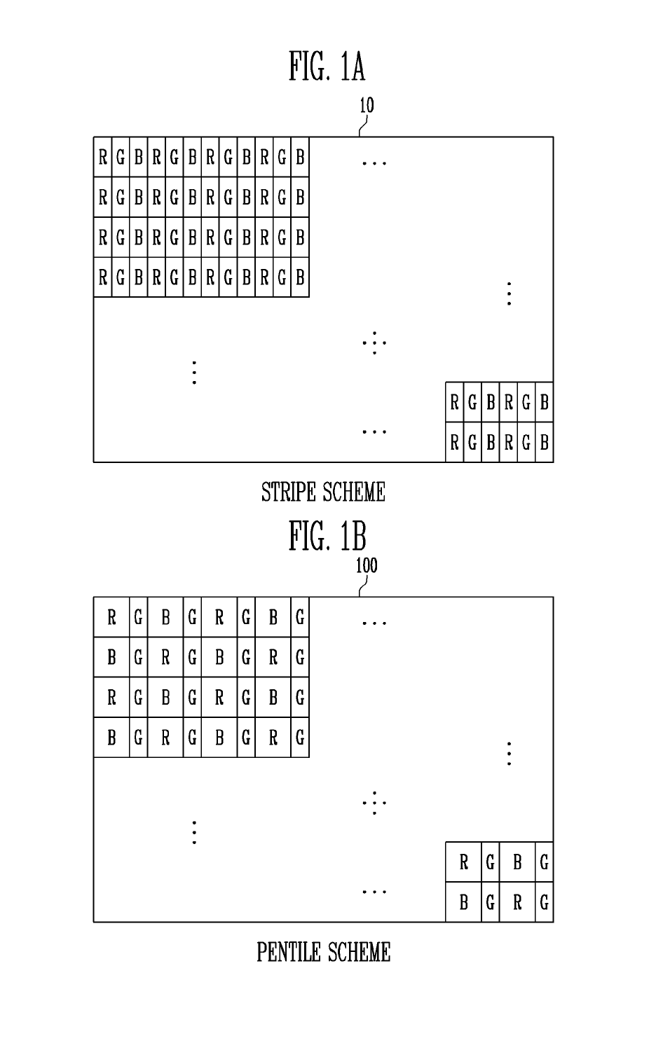

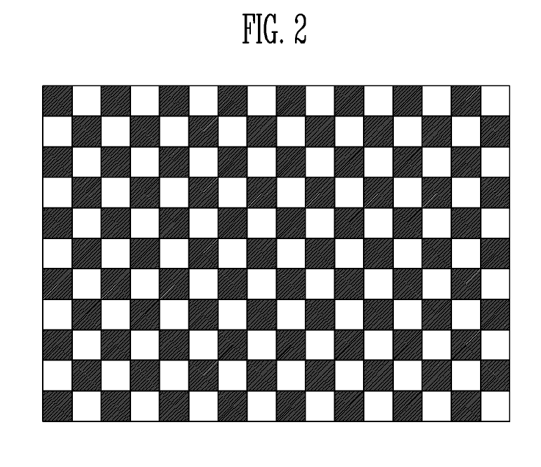

FIGS. 1A and 1B are diagrams illustrating pixel arrangement structures by a stripe scheme and a pentile scheme respectively. Further, FIG. 2 is a diagram illustrating an example of a micro pattern displayed in a pixel unit.

Referring to FIG. 1A, in a stripe scheme, each of first color pixels, second color pixels, and third color pixels is arranged in a pixel column unit in a vertical direction, and the arrangement is repeated, so that a pixel unit 10 in a stripe form is configured.

In the stripe scheme, the numbers of first to third color pixels are set to be the same, and one first color pixel, one second color pixel, and one third color pixel configures one unit pixel.

By contrast, referring to FIG. 1B, in a pentile scheme, first color pixels and second color pixels are alternately arranged, and third color pixels are continuously arranged in each pixel column unit in a vertical direction. Further, the pixel columns, in which the first color and second color pixels adjacent to the pixel column including the continuously arranged third color pixels are alternately arranged, are arranged in a checker board form, in which the first color and second color pixels are arranged in a reverse order to configure the pixel unit 100.

The first color pixel may be, for example, a red (R) pixel, and the second pixel may be, for example, a blue (B) pixel. Further, the third color pixel may be, for example, a green (G) pixel.

In the pentile type display device, the number of each of first color pixels and second color pixels is set to be a half of the number of third pixels, and high resolution compared to the number of pixels is expressed by using a sub-pixel rendering scheme.

However, it is difficult for the pentile type display device to display a specific pattern, such as a micro pattern, with high definition, and particularly, color coordinates are distorted when the micro pattern is displayed, so that a white balance may be lost.

For example, when the pentile type display device displays a micro black and white mosaic pattern implemented in a small lattice dot pattern illustrated in FIG. 2 or a micro pattern, such as a thin vertical line pattern, different loads are applied to the first color to third color pixels, so that color coordinates are distorted and thus an image quality may deteriorate.

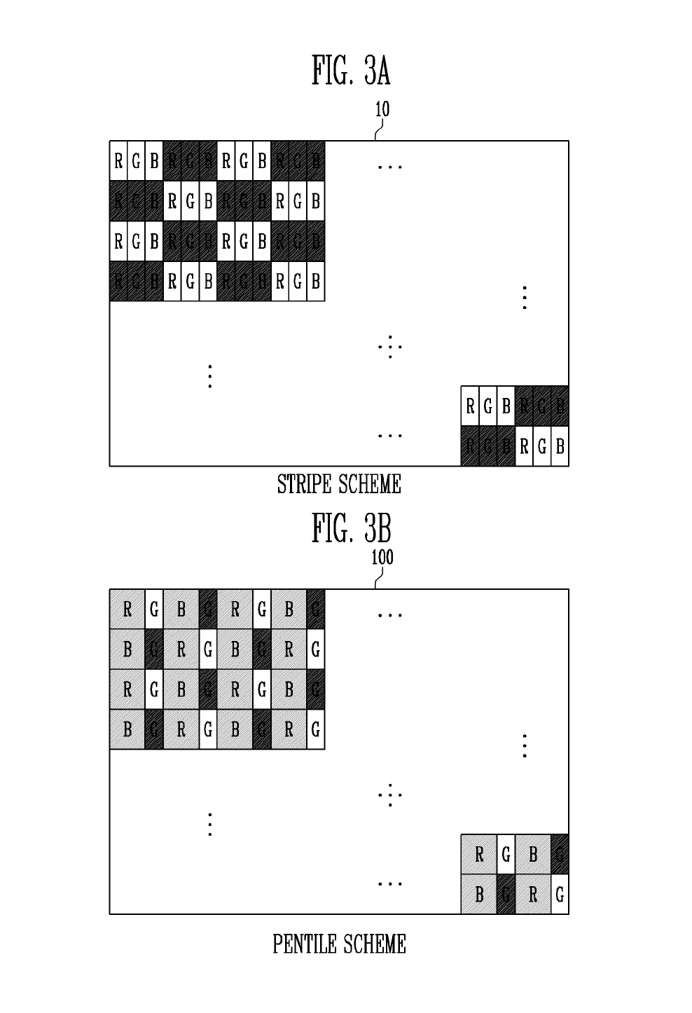

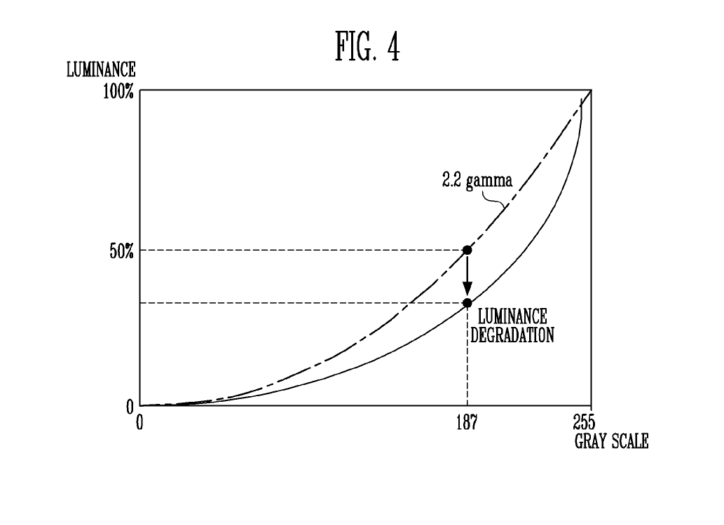

FIGS. 3A and 3B are diagrams illustrating methods of displaying the micro pattern illustrated in FIG. 2 by the stripe scheme and the pentile scheme respectively. Particularly, FIGS. 3A and 3B illustrate methods of expressing a pattern in the unit of one unit pixel or a small lattice form which is small similarly to the unit pixel as an example. FIG. 4 is a graph illustrating generation of luminance degradation when a micro pattern is displayed.

Referring to FIG. 3A, when the display unit 10 by the stripe scheme displays a micro black and white dot pattern having a small lattice form having a size of the unit pixel, a half of the total number of pixels of each of the first color, second color, and third color pixels is turned on at a degree corresponding to a white gray scale, and the residual half thereof is turned off to display a black and white dot pattern.

In the meantime, referring to FIG. 3B, when the display unit 100 by the pentile scheme displays the same black and white dot pattern, all of the first color (for example, red) and second color (for example, blue) pixels, which are alternately disposed in the same pixel column and included by a half of the number of third color (for example, green) pixels, are turned on at luminance of 50%. However, a half of the third color pixels are turned on at a degree corresponding to a white gray scale, and the remaining half of the third color pixels are turned on at a degree corresponding to a black gray scale in response to the dot pattern desired to be displayed.

Accordingly, a large load is applied to the first color and second color pixels, all of which are turned on at luminance of 50%, compared to the third color pixels, of which a half is only turned on at luminance of 100%.

This generates a large loading effect in the first color and second color pixels, so that luminance is degraded at 187 GRAY SCLAE as illustrated in FIG. 4. This drops a gamma curve, so that a gamma value deviates from a reference value, for example, 2.2 gamma.

However, when a gamma value of the display device is tuned, the gamma value is tuned to be optimized for a reference gamma value, for example, 2.2 gamma, by measuring the gamma value by a luminance meter in a state where all of the pixels of the first color through the third color pixels are turned on at a gray scale, for example, 0 to 255 gray scale, so that a load difference incurable in the first color through the third color pixels is not sufficiently considered.

Accordingly, when a specific pattern having a distinctively large load difference between the first and the second color pixels and the third color pixel is displayed, luminance of the first color and second color pixels does not reach target luminance, so that the color coordinates may be distorted to lean to the third color. This distorts white balance.

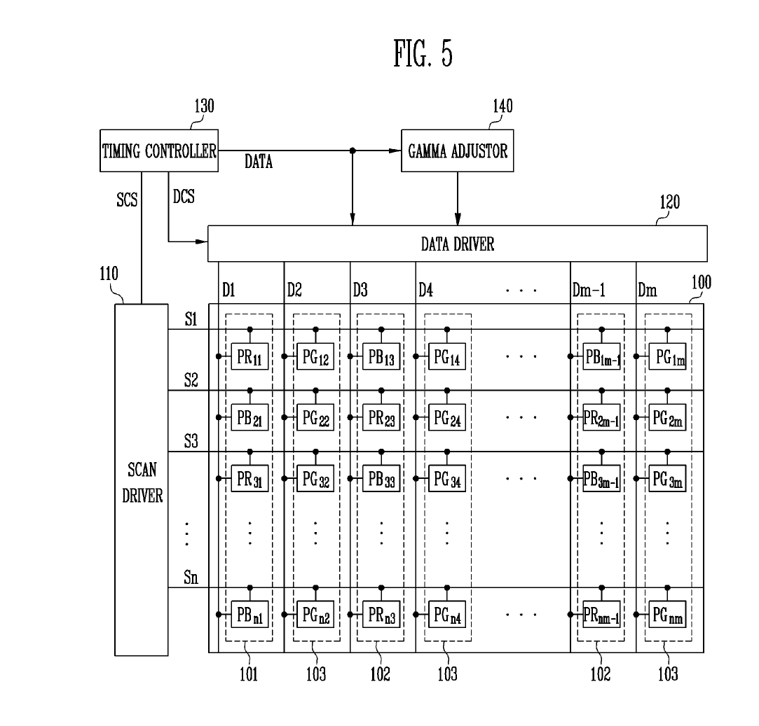

In this respect, the present invention provides a display device capable of preventing color-coordinate distortion and improving an image quality when displaying a specific pattern, such as a micro pattern, in a pentile type display device, and a driving method thereof, and will be described with reference to FIGS. 5 to 7 in more detail.

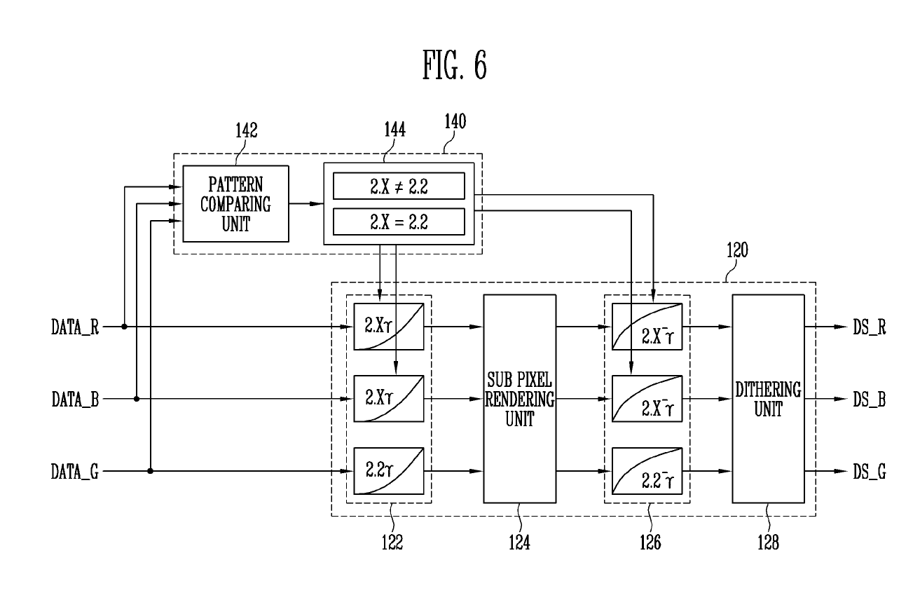

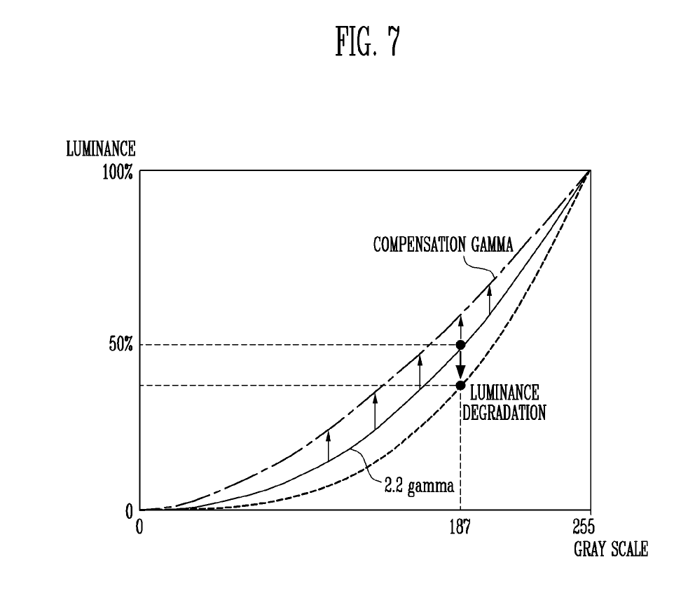

FIG. 5 is a diagram illustrating a display device according to an exemplary embodiment of the present invention, and FIG. 6 is a diagram illustrating an exemplary embodiment of a gamma adjustor and a data driver illustrated in FIG. 5. Further, FIG. 7 is a graph illustrating compensation for luminance degradation when a micro pattern is displayed by adopting the exemplary embodiment of the present invention.

Referring to FIG. 5, the display device according to an exemplary embodiment of the present invention includes a pixel unit 100, a scan driver 110, a data driver 120, and a timing controller 130, and further includes a gamma adjustor 140 for adjusting a gamma value in response to input data DATA from the timing controller 130 and outputting the adjusted gamma value. The configuration of the data driver 120 and the scan driver 110 is not limited to what is disclosed in FIG. 5 and it may vary in different forms. For example, the data and scan drivers may be disposed together at one side of the pixel unit.

The pixel unit 100 has a pixel arrangement structure in which pixels are arranged in a pentile scheme.

More particularly, the pixel unit 100 includes a first pixel column 101, in which first color pixels, for example, red pixels PR, and second color pixels, for example, blue pixels PB, are alternately arranged, a second pixel column 102, in which the first color pixels PR and the second color pixels PB are alternately arranged in a reverse order of the first pixel column 101, and a third pixel column 103, in which third color pixels, for example, green pixels PG, are arranged, disposed between the first pixel column 101 and the second pixel column 102, and such a pixel arrangement structure is repeated to configure the pentile pixel unit 100.

The scan driver 110 generates a scan signal in response to a scan control signal SCS from the timing controller 130, and supplies the scan signal to the pixels PR, PB, and PG through scan lines S1 to Sn.

The data driver 120 generates a data control signal in response to a data control signal DCS and the input data DATA from the timing controller 130, and supplies the data signal to the pixels PR, PB, and PG through data lines D1 to Dm.

Particularly, the data driver 120 generates a first color data signal, a second color data signal, and a third color data signal in response to the input data DATA and supplies the generated first color data signal, second color data signal, and third color data signal to the pixel unit 100, in such a manner that a gamma value from the gamma adjustor 140 is applied when generating the first color data signal and/or the second color data signal. Further, the data driver 120 may apply a gamma value from the gamma adjustor 140 when generating the third color data signal.

The timing controller 130 supplies the scan control signal SCS and the data control signal DCS to the scan driver 110 and the data driver 120, respectively. Further, the timing controller 130 supplies the input data to the data driver 120 and the gamma adjustor 140.

The gamma adjustor 140 outputs a predetermined gamma value to the data driver 120, in such a manner that when the input data DATA corresponding to a predetermined specific pattern is supplied, the gamma adjustor 140 adjusts and outputs a first color gamma value and/or a second color gamma value.

That is, the gamma adjustor 140 according to the exemplary embodiment of the present invention detects whether a specific pattern is input in response to the input data DATA, and when the specific pattern is detected, the gamma adjustor 140 adjusts and outputs the first color gamma value and/or the second color gamma value to the data driver 120.

Particularly, the gamma adjustor 140 adjusts at least one of the first color gamma value and the second color gamma value so that luminance of the first color pixel PR and/or the second color pixel PB is increased for a specific pattern having large luminance degradation in the first color pixel PR and/or the second color pixel PB, and outputs the adjusted gamma value.

For example, as illustrated in FIGS. 2 and 3, the gamma adjustor 140 may adjust all of the first color gamma value and the second color gamma value so to increase luminance of the first color pixel PR and the second color pixel PB for a specific pattern having large luminance degradation in the first color pixel PR and the second color pixel PB, and outputs the adjusted gamma values. In this case, the first gamma value and the second gamma value may be set to be the same as each other or different from each other. For example, when the specific pattern is input, the first gamma value and the second gamma value may be set to be the same as each other, and only a third gamma value may be set to be different, or all the gamma values of first color, second color, and third color may be set to be different from one another.

In the meantime, when the predetermined specific pattern is not detected, the gamma adjustor 140 outputs the first color gamma value and the second color gamma value in accordance with the reference gamma value, for example, 2.2 gamma.

Further, the gamma adjustor 140 may set the predetermined reference gamma value, for example, 2.2 gamma, as a gamma value of the third color pixel PG, regardless of the specific pattern, and supply the gamma value to the data driver 120. However, when the data driver 120 outputs the third color input data by performing only dithering on third color input data without performing gamma conversion and inverse gamma conversion, the gamma adjustor 140 may not output the third color gamma value.

More particularly, as illustrated in FIG. 6, the data driver 120 according to the exemplary embodiment of the present invention includes an input gamma unit 122, a sub pixel rendering unit 124, an output gamma unit 126, and a dithering unit 128. Further, the gamma adjustor 140 includes a pattern comparing unit 142 and a gamma value setting unit 144.

First, a configuration of the data driver 120 will be described. The input gamma unit 122 gamma-converts at least first color input data DATA_R and second color input data DATA_B among the input data DATA by applying the first color gamma value and the second color gamma value supplied from the gamma adjustor 140 and outputs the gamma-converted first color input data DATA_R and second color input data DATA_B. In this case, the first color gamma value and the second color gamma value may be set to the same gamma value, for example, 2.Xγ, and a value of X may vary. However, the present invention is not limited thereto, and the first color gamma value and the second color gamma value may also be set differently from each other.

Further, the input gamma unit 122 may gamma-convert third color input data DATA_G among the input data DATA by applying the predetermined third color gamma value, for example, the reference gamma value, which is set to 2.2γ. In the meantime, the present invention is not limited to the case where the third color gamma value is essentially set to a fixed value, and the third color gamma value may also be designed to be adjusted.

However, the third color input data DATA_G may not be gamma converted/inversely gamma converted and/or sub-pixel rendered, but may be directly input into the dithering unit 128 and subject only to the dithering. In this case, a circuit unit for performing the gamma/inverse gamma conversion on the third color input data DATA_G may be omitted. That is, the data driver 120 may at least perform the dithering on the third color input data DATA_G and output the dithered third color input data DATA_G.

The sub pixel rendering unit 124 renders and outputs an output value from the input gamma unit 122 in accordance with the pixel arrangement structure, that is, the pentile pixel arrangement structure, of the pixel unit 100. That is, the sub pixel rendering unit 124 renders the input data, for example, the third color input data DATA_G and/or the gamma converted input data, for example, the first color and second color input data DATA_R and DATA_B, in accordance with the pixel arrangement structure of the pixel unit 100 and outputs the rendered input data.

The output gamma unit 126 inversely gamma-converts an output value of the sub pixel rendering unit 124 and outputs the inversely gamma-converted output value. In this case, the output gamma unit 126 inversely gamma-converts at least the first color input data DATA_R and the second color input data DATA_B by applying the first color and second color gamma values from the gamma adjustor 140.

Further, the gamma output unit 126 may inversely gamma-convert the third color input data DATA_G, which is gamma-converted by the input gamma unit 122, by applying the predetermined third color gamma value, for example, the reference gamma value of 2.2γ. In the meantime, when the third color gamma value is designed to be adjusted, the input/output gamma unit 122 and 126 may receive the third color gamma value from the gamma adjustor 140 to be driven.

The dithering unit 128 dithers an output value of the output gamma unit 126, and outputs the dithered output value as first color, second color, and third color data signals DS_R, DS_B, and DS_G. The first color, second color, and third color data signals DS_R, DS_B, and DS_G includes gray information corresponding to the first color, second color, and third color pixels PR, PB, and PG.

Next, a configuration of the gamma adjustor 140 will be described. The pattern comparing unit 142 compares the input data DATA_R, DATA_B, and DATA_G with a reference pattern value, and outputs a comparison result.

More particularly, the pattern comparing unit 142 compares, for example, for a specific pattern having large luminance degradation of the first color pixel PR and the second color pixel PB, the input data DATA_R, DATA_B, and DATA_G with a predetermined reference pattern value (data comparison value) to detects a specific pattern. To this end, the pattern comparing unit 142 may include a memory (not shown) in which the reference pattern value for the predetermined specific pattern is stored.

The pattern comparing unit 142 supplies a selection signal for determining whether to adjust the first color and/or second color gamma value (2.Xγ) and/or an adjustment degree according to a result of the comparison.

The gamma value setting unit 144 sets at least the first color and second color gamma values (2.Xγ) in response to the selection signal from the pattern comparing unit 142, and supplies the set gamma value to the data driver 120.

For example, when a selection signal corresponding to the specific pattern is supplied, the gamma value setting unit 144 may set the first color and second color gamma values (2.Xγ) to a value different from the third color gamma value (2.2γ), and particularly, may set the first color and second color gamma values (2.Xγ) so that luminance of the first color and second color pixels PR and PB may increase. Further, although it is not illustrated in FIG. 6, the gamma value setting unit 144 may selectively output the third color gamma value, and for example, may set the third color gamma value to the reference gamma value (2.2γ) or output an adjusted third color gamma value.

For example, the gamma value setting unit 144 may select a compensation gamma value having a greater gamma value than the reference gamma value (2.2γ) as illustrated in FIG. 7, and set the compensation gamma value as the first color and second color gamma values (2.Xγ). To this end, the gamma value setting unit 144 may include a memory (not shown) in which information on a predetermined compensation gamma value in response to a predetermined selection signal and information on the reference gamma value are stored.

Accordingly, even when luminance is degraded due to a loading effect in the first color and second color pixels PR and PB, the exemplary embodiment of the present invention may adjust the first color and second color gamma values to have a level similar to the reference gamma value (2.2γ).

By contrast, in the comparison example in that set the first color and second color gamma values to the reference gamma value (2.2γ) regardless of the display of the specific pattern, the first color and second color gamma values may not reach the reference gamma value (2.2γ) due to luminance degradation.

In summary, the driving method of the display device according to the exemplary embodiment of the present invention includes comparing input data DATA with a reference pattern value and setting first color and second color gamma values (2.Xγ) in response to a result of the comparison, and generating first color and second color data signals DS_R and DS_B corresponding to the input data DATA by applying the first color and second color gamma values (2.Xγ), and a third color data signal DS_G corresponding to the input data DATA. Further, the first color to third color pixels PR, PB, and PG are driven with luminance corresponding to the first color to third color data signals DS_R, DS_B, and DS_G.

Particularly, according to the driving method of the display device according to the exemplary embodiment of the present invention, when a specific pattern is detected according to the result of the comparison between the input data DATA and the reference pattern value, at least one of the first color and second color gamma values (2.Xγ), for example, all of the first color and second color gamma values (2.Xγ), is adjusted to compensate luminance degradation.

According to the exemplary embodiment of the present invention and the driving method thereof, when input data DATA corresponding to a specific pattern, such as a micro pattern, are put into a pentile type display device, it is possible to adjust gamma values of the first color pixel PR and/or the second color pixel PB having a greater load than that of the third color pixel PG. Consequently, it may compensate luminance degradation of the first color pixel PR and/or the second color pixel PB, thereby preventing color-coordinate distortion and improving image quality in general.

In summary, since the pentile type display device includes the less number of pixels compared to resolution, it is difficult to display a specific pattern, such as a micro pattern, with high definition.

For example, when the pentile type display device displays a micro pattern, such as a micro black and white mosaic pattern or a thin vertical line pattern, different loads are applied to first color through third color pixels, so that color coordinates may be distorted to degrade image quality.

According to the display device according to the exemplary embodiment of the present invention and the driving method thereof, when a pentile type display device displays a specific pattern, such as a micro pattern, luminance degradation is compensated by adjusting gamma values of the first color pixel and/or the second color pixel having a relatively large load. Accordingly, it is possible to improve image quality when a pentile type display device displays a specific pattern.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. A display device, comprising:
a pixel unit including a first pixel column, in which first color pixels and second color pixels are alternately arranged, a second pixel column, in which the first color pixels and the second color pixels are alternately arranged in a reverse order to that of the first pixel column, and a third pixel column, in which third color pixels are arranged, disposed between the first pixel column and the second pixel column;
a data driver configured to generate a first color data signal, a second color data signal, and a third color data signal in response to input data, and supply the generated data signals to the pixel unit; and
a gamma adjustor configured to detect a specific pattern based on the input data, adjust at least one of a first color gamma value and a second color gamma value when the specific pattern detected, and output the adjusted gamma value to the data driver.

2. The display device of claim 1, wherein the gamma adjustor adjusts at least one of the first color gamma value and the second color gamma value so as to increase luminance when the specific pattern is detected.

3. The display device of claim 1, wherein the gamma adjustor adjusts the first color gamma value and the second color gamma value in accordance with a reference gamma value and outputs the adjusted first color and second color gamma values when the specific pattern is not detected.

4. The display device of claim 1, wherein the gamma adjustor includes:
a pattern comparison unit configured to compare the input data with a reference pattern value, and output a result of the comparison; and
a gamma value setting unit configured to set the first color gamma value and the second color gamma value based on the result of the comparison, and supply the set first color gamma value and second color gamma value to the data driver.

5. The display device of claim 1, wherein the gamma adjustor further outputs a predetermined third color gamma value to the data driver.

6. The display device of claim 1, wherein the data driver includes:
an input gamma unit configured to gamma convert at least one of first color input data and second color input data among the input data by applying the first color gamma value and the second color gamma value from the gamma adjustor, and output the gamma converted first color input data and second color input data;
a sub pixel rendering unit configured to render an output value of the input gamma unit in accordance with a pixel arrangement structure of the pixel unit and output the rendered output value;
an output gamma unit configured to inversely gamma convert an output value of the sub pixel rendering unit and output the inversely gamma converted output value; and
a dithering unit configured to dither an output value of the output gamma unit and output the dithered output value.

7. The display device of claim 6, wherein the data driver at least dithers third color input data among the input data.

8. A method of driving a display device, which comprises a pixel unit including a first pixel column, in which first color pixels and second color pixels are alternately arranged, a second pixel column, in which the first color pixels and the second color pixels are alternately arranged in a reverse order to that of the first pixel column, and a third pixel column, in which third color pixels are arranged, disposed between the first pixel column and the second pixel column, the method comprising:
comparing input data with a reference pattern value, and setting at least one of a first color gamma value and a second color gamma value in response to a result of the comparison;
detecting a specific pattern according to the result of the comparison between the input data and the reference pattern value;
adjusting at least one of the first color gamma value and the second color gamma value;
generating a first color data signal and a second color data signal corresponding to the input data by applying the first color gamma value and the second color gamma value, and a third color data signal corresponding to the input data; and
driving pixels at luminance corresponding to the first color data signal, the second color data signal and the third color data signal.

9. The method of claim 8, wherein when the specific pattern is detected, at least one gamma value between the first color gamma value and the second color gamma value is adjusted so as to increase luminance.

10. The method of claim 8, wherein when the specific pattern is not detected, the first color gamma value and the second color gamma value are set in accordance with a reference gamma value.

11. The method of claim 8, wherein the generating of the first color data signal, the second color signal and the third color data signal includes sub pixel rendering of rendering the input data or gamma converted input data in accordance with a pixel arrangement structure of the display unit.

12. A display device, comprising:
a pixel unit in which the number of each first color pixels and a second color pixels is set to be a half of the number of third color pixels;
a gamma adjustor adjusting and outputting at least one of a first color gamma value and a second color gamma value when input data corresponding to a predetermined specific pattern is supplied; and
a data driver generating at least one of a first color data signal and a second color data signal by applying at least one of the adjusted gamma values supplied from the gamma adjustor.

13. The display device of claim 12, wherein the gamma adjustor outputs the first color gamma value and the second color gamma value in accordance with the reference gamma value when the predetermined specific pattern is not detected.

14. The display device of claim 13, wherein the gamma adjustor outputs the reference gamma value as a gamma value of the third color pixels regardless of the predetermined specific pattern.

15. The display device of claim 12, wherein the gamma adjustor includes:
a pattern comparison unit configured to compare the input data with a reference pattern value, and to output a result of the comparison; and
a gamma value setting unit configured to set the first color gamma value and the second color gamma value based on the result of the comparison, and to supply the set first color gamma value and second color gamma value to the data driver.
